(19) United States
(12) Patent Application Publication
(10) Pub. No.: US 2013/0195586 A1
(43) Pub. Date: Aug. 1, 2013

(54) TRANSMISSION MECHANISM, SUBSTRATE POSITIONING DEVICE AND ROBOT

(71) Applicant: KABUSHIKI KAISHA YASKAWA DENKI, Fukuoka (JP)

(72) Inventor: Masatoshi FURUICHI, Fukuoka (JP)

(73) Assignee: KABUSHIKI KAISHA YASKAWA DENKI, Fukuoka (JP)

(21) Appl. No.: 13/669,777

(22) Filed: Nov. 6, 2012

(30) Foreign Application Priority Data
Jan. 30, 2012 (JP) 2012-016871

(51) Int. Cl. F16H 7/02; B65G 47/74; B32B 38/10

(52) U.S. Cl. 414/222.01; 474/148; 156/137; 901/21

(57) ABSTRACT

A transmission mechanism includes: a drive pulley which is provided on a drive shaft and has external teeth with a predetermined pitch width; a driven pulley which is provided on a driven shaft and has external teeth with the pitch width; and a belt having internal teeth with the pitch width which engage with the external teeth of the drive pulley and the driven pulley. Further, the belt includes sub-belts having a periodic variation characteristic in which the pitch width varies periodically, and the sub-belts are arranged in a state where phases of the periodic variation characteristic thereof are shifted from each other.

### CROSS-REFERENCE TO RELATED APPLICATIONS

The present disclosure contains subject matters related to that disclosed in Japanese Priority Patent Application No. 2012-016871 filed with the Japan Patent Office on Jan. 30, 2012, the entire contents of which are incorporated herein by reference.

### BACKGROUND OF THE INVENTION

1. Field of the Invention

An embodiment disclosed herein relates to a transmission mechanism, a substrate positioning device and a robot.

2. Background of the Invention

Conventionally, there has been known a transmission mechanism which includes a motor, a belt and pulleys and the like to transmit the rotation of the motor between two parallel axes.

The transmission mechanism is used in an alignment device or the like which performs positioning of a substrate such as a wafer when the substrate is transferred by a robot in a space formed in a local clean device called, e.g., an equipment front end module (EFEM). Hereinafter, the alignment device is described as “substrate positioning device.”

Specifically, the substrate positioning device is configured such that a first pulley is fixed to an output shaft of a motor, a second pulley which is fixed to a support shaft of a table on which the substrate is mounted, and a belt is wrapped around the first and the second pulley. Accordingly, the substrate positioning device performs positioning of a substrate by moving the table depending on movement of the motor (see, e.g., Japanese Patent. Laid-open Publication No. 2004-200643). Further, a toothed belt made of rubber is generally used as the belt.

However, in the conventional transmission mechanism using the toothed belt, the rotation of the motor may not be accurately transmitted. This is because a width between teeth pitches of the toothed belt (hereinafter, referred to as a “teeth pitch width”) may vary due to an error at the time of molding.

Such a problem may arise in the same way in a robot which drives an arm by using the transmission mechanism as well as the substrate positioning device.

### SUMMARY OF THE INVENTION

A transmission mechanism in accordance with an aspect of an embodiment disclosed herein includes a drive pulley, a driven pulley and a belt. The drive pulley is provided on a drive shaft and has external teeth with a predetermined pitch width. The driven pulley is provided on a driven shaft and has external teeth with the pitch width. The belt has internal teeth engaging with the external teeth of the drive pulley and the driven pulley and having the same pitch width as that of the external teeth of the drive pulley and the driven pulley. Further, the belt includes sub-belts having a periodic variation characteristic, in which the teeth pitch width varies periodically, and the sub-belts are arranged in a state where phases of the periodic variation characteristic of the teeth pitch widths are shifted from each other.

### BRIEF DESCRIPTION OF THE DRAWINGS

The objects and features of the present disclosure will become apparent from the following description of embodiments, given in conjunction with the accompanying drawings, in which:

FIG. 1 is a schematic diagram showing an overall configuration of a transfer system including a substrate positioning device and a robot in accordance with an embodiment;

FIG. 2A is a schematic perspective view showing a configuration of the substrate positioning device in accordance with the embodiment;

FIG. 2B is a schematic enlarged view of a sensor unit;

FIG. 3A is a schematic top view of a transmission mechanism in accordance with the embodiment;

FIG. 3B is a schematic enlarged view of the portion M1 shown in FIG. 3A;

FIGS. 4A and 4B are views for illustrating an example of shifting the phase of the belt;

FIG. 5 is a graph showing the phase shift between a driven pulley and a drive pulley;

FIGS. 6A and 6B are graphs snowing experimental results of an amount of the phase shift between the driven pulley and the drive pulley;

FIG. 7A is a diagram showing an example of molding of sub-belts;

FIG. 7B is a diagram showing an example of arrangement of sub-belts;

FIG. 7C is a diagram snowing another example of arrangement of sub-belts; and

FIG. 8 is a schematic side view showing a configuration of the robot in accordance with the embodiment.

### DETAILED DESCRIPTION OF THE EMBODIMENTS

Hereinafter, an embodiment of a transmission mechanism, a substrate positioning device, and a robot will be described in detail with reference to the accompanying drawings which form a part hereof. Further, it is not intended that the embodiment be limited to the specific details described below.

Further, the following description will be given using, for example, a transfer system configured to transfer a semiconductor wafer using a robot. Herein, a “semiconductor wafer” is simply referred to as a “wafer,” an “end effector” of the robot is referred to as “hand,” and a “toothed belt” is referred to as “belt.”

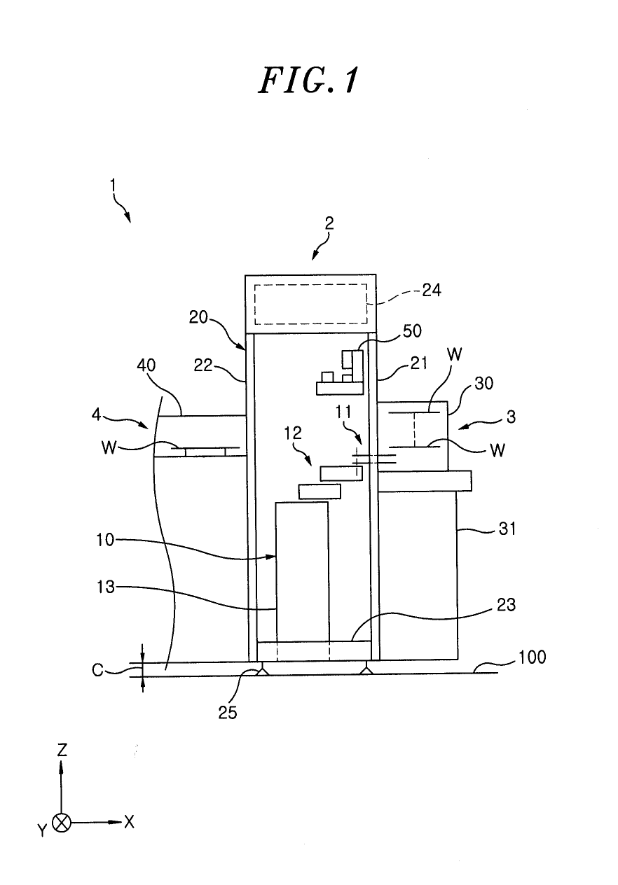

First, an overall configuration of the transfer system including the substrate positioning device and the robot in accordance with the embodiment will be described with reference to FIG. 1. FIG. 1 shows an overall configuration of a transfer system 1 including the substrate positioning device and the robot in accordance with the embodiment.

For the sake of understanding of the description, a three-dimensional Cartesian coordinate system including a Z-axis whose positive and negative direction are vertically upward and downward (i.e., “vertical direction”), respectively, is illustrated in FIG. 1. Thus, the direction along the XY plane refers to “horizontal direction.” The Cartesian coordinate system may be shown in the same way in the other drawings used in the following description.

Further, in the following description, a reference numeral may be assigned to only one component among a plurality of components, and assignment of reference numerals to the other components may be omitted. In this case, it is assumed that the other components have the same configuration as the component to which the reference numeral is assigned.

As shown in FIG. 1, the transfer system 1 includes a substrate transfer unit 2, a substrate supply unit 3, and a substrate processing unit 4. The substrate transfer unit 2 includes a robot 10, and a housing 20 in which the robot 10 is disposed. The substrate supply unit 3 is provided on one side surface 21 of the housing 20, and the substrate processing unit 4 is provided on the other side surface 22 of the housing 20. Further, reference numeral 100 in the figure denotes a mounting surface of the transfer system 1.

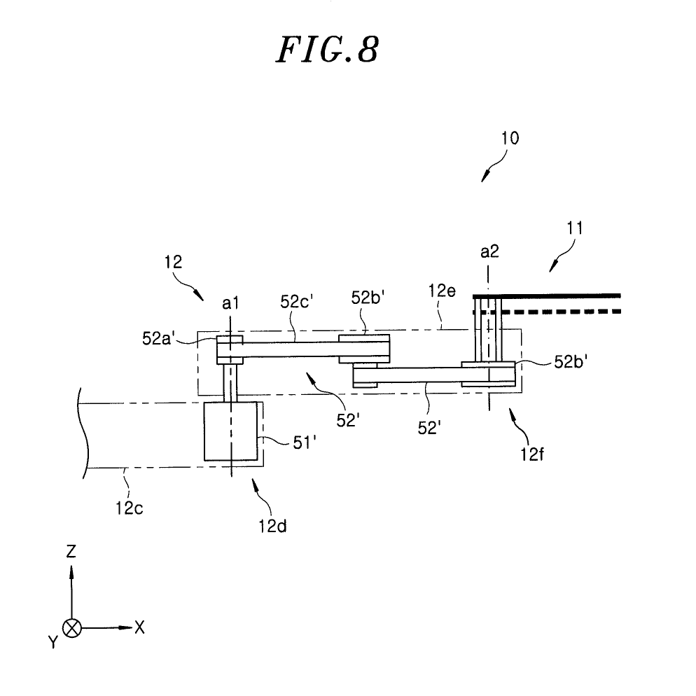

The robot 10 includes an arm unit 12 having a hand 11 capable of holding wafers W to be transferred in two, i.e., an upper and a lower stage. The arm unit 12 is supported to be rotatable in the horizontal direction and to be vertically movable with respect to a base 13. The base 13 is mounted on a base mounting frame 23 forming a bottom wall of the housing 20. Further, the robot 10 will be described later with reference to FIG. 8.

In the housing 20, a down flow of clean air is formed via a filter unit 24 which is a so-called equipment front end module (EFEM) and is provided at the top of the housing 20. By this down flow, the inside of the housing 20 is maintained in a high cleanliness state. Further, legs 25 are provided on the lower surface of the base mounting frame 23 to support the housing 20 while maintaining a predetermined clearance C between the housing 20 and the mounting surface 100.

The substrate supply unit 3 includes a hoop 30 accommodating a plurality of wafers W in multiple stages in the vertical direction, and a hoop opener (not shown) performing the opening and closing of a lid of the hoop 30 to allow the wafer W to be taken out into the housing 20. Further, multiple sets, each having the hoop 30 and the hoop opener may be provided at predetermined intervals on a table 31 having a predetermined height.

The substrate processing unit 4 is a processing unit performing a predetermined process such as a cleaning process, a film forming process, and a photolithography process on the wafer W in a semiconductor manufacturing process. The substrate processing unit 4 includes a processing device 40 performing the predetermined process. The processing device 40 is disposed on the other side surface 22 of the housing 20 opposite to the substrate supply unit 3 with the robot 10 therebetween.

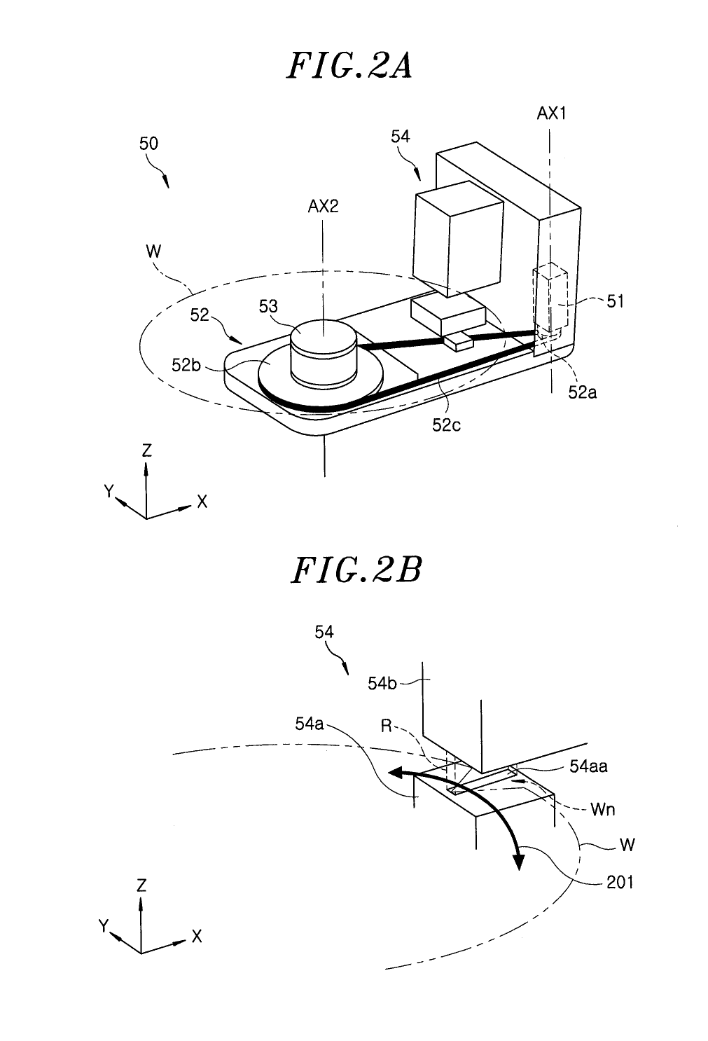

Further, a substrate positioning device 50 is disposed in the housing 20 to perform the positioning of the wafer W. The substrate positioning device 50 will be described in detail later with reference to FIG. 2A and so on.

Based on such a configuration, in the transfer system 1, a wafer W is taken out from the hoop 30 and loaded into the processing device 40 through the substrate positioning device 50 by the robot 10 performing the lifting and rotating operation. Then, the wafer W that has been subjected to a predetermined process in the processing device 40 is unloaded and transferred by the lifting and rotation operation of the robot 10 and then accommodated in the hoop 30.

Next, a configuration of the substrate positioning device 50 in accordance with the embodiment will be described with reference to FIG. 2A. FIG. 2A is a schematic perspective view showing the configuration of the substrate positioning device 50 in accordance with the embodiment.

As shown in FIG. 2A, the substrate positioning device 50 includes a motor 51, a transmission mechanism 52, a mounting table 53, and a sensor unit 54. The transmission mechanism 52 includes a drive pulley 52a, a driven pulley 52b, and a belt 52c.

The motor 51 is a driving source for rotating an axis AX1. At an output shaft (i.e., a drive shaft, hereinafter described as the axis AX1) of the motor 51, the drive pulley 52a of the transmission mechanism 52 is provided, and rotated along with the rotation of the motor 51. Further, the rotation angle of the motor 51 (i.e., the rotation angle of the drive pulley 52a) is detected by an encoder (not shown) or the like.

The driven pulley 52b is provided rotatably about a rotation shaft (not shown) (i.e., driven shaft, hereinafter described as an axis AX2) around an axis AX2.

Further, the belt 52c is wrapped around the drive pulley 52a and the driven pulley 52b. The belt 52c transmits the rotation of the drive pulley 52a to rotate the driven pulley 52b.

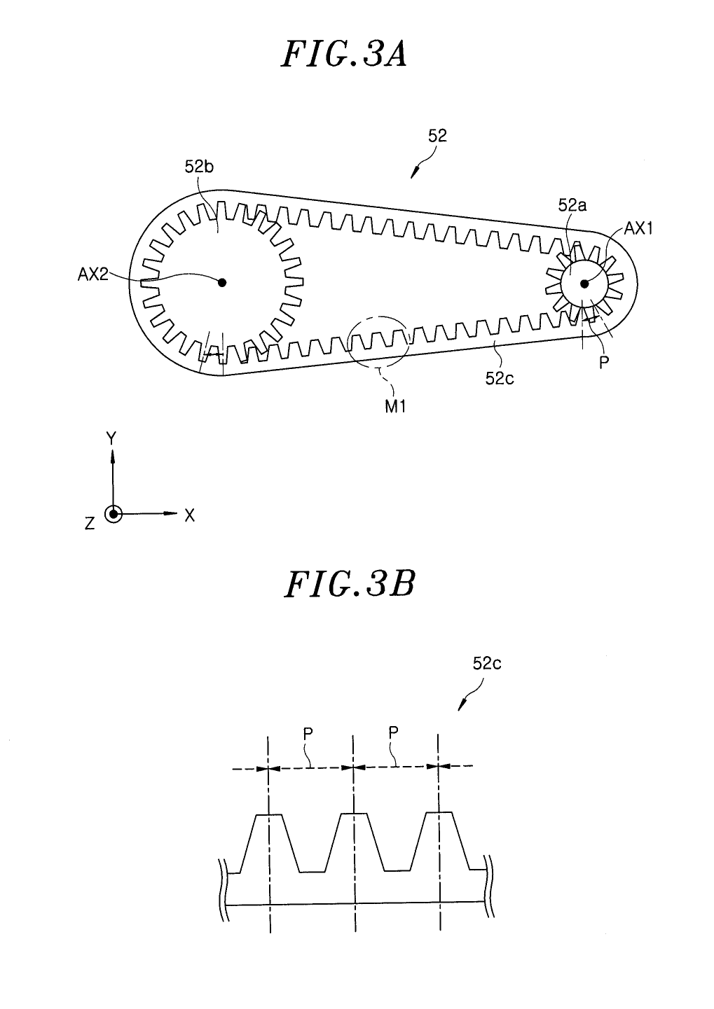

The shape and the like of the drive pulley 52a, the driven pulley 52b and the belt 52c will, be described in detail with reference to FIGS. 3A and 3B.

Further, the mounting table 53 for mounting the wafer W thereon is connected to the driven pulley 52b. As the driven pulley 52b is driven to rotate, the mounting table 53 rotates the mounted wafer W such that position of the wafer W is aligned. The position alignment will be described later with reference to FIG. 2F.

Although not shown, an adsorption unit may be provided to adsorb the wafer W onto the mounting table 53. Accordingly, the wafer W can be held by a predetermined holding force (i.e., adsorption force) to prevent displacement due to a centrifugal force, thereby improving the accuracy of position alignment.

The sensor unit 54 is a detection unit for detecting, e.g., a cutout provided on the periphery of the wafer W (hereinafter described as a “notch”). In this embodiment, a case where the sensor unit 54 is configured using an optical sensor will be described by way of example, but it is not intended to limit the configuration of the sensor unit 54.

Here, the position alignment of the wafer W will be described with reference to FIG. 2B. FIG. 2B is a schematic enlarged view of the sensor unit 54. As shown in FIG. 2B, the sensor unit 54 includes a light receiving part 54a and a light emitting part 54b. Also, the light receiving part 54a includes a line sensor 54aa.

The light receiving part 54a and the light emitting part 54b are disposed to face each other with a gap therebetween through which the edge of the wafer W passes. At this gap, an optical axis R is formed by light from the light emitting part 54b. Further, the line sensor 54aa detects a notch Wn based on a change in light quantity of the optical axis R when the wafer W is rotated while blocking the optical axis R.

That is, the substrate positioning device 50 performs the position alignment of the wafer W by rotating the mounting table 53 until the line sensor 54aa detects the notch Wn. Further, the position alignment of the wafer W may be performed by detecting the edge of the wafer W based on a change in light intensity and then calculating an amount of eccentricity and the like. Alternatively, after capturing an image of the wafer W, the position alignment of the wafer W may be performed based on the captured image.

Further, the sensor unit 54 also detects the rotation angle of the wafer W (see arrow 201 in the FIG. 2B) in the position alignment. When the rotation angle of the wafer W (i.e., the rotation angle of the driven pulley 52b) accurately matches the rotation angle of the drive pulley 52a detected by the encoder or the like as described above, it is regarded that the position alignment is performed with good accuracy.

That is, it is important that the rotation of the drive pulley 52a is accurately transmitted to the driven pulley 52b. Thus, in the transmission mechanism 52 in accordance with the embodiment, the belt 52c is constituted by a plurality of sub-belts and phases of the periodic variation characteristic of the teeth pitch width of the sub-belts are shifted from each other, thereby equalizing the periodic variation characteristic of the teeth pitch width of the belt 52c. This will be described in detail below.

FIG. 3A is a schematic top view of the transmission mechanism 52 in accordance with the embodiment, and FIG. 3B is a schematic enlarged view of portion M1 shown in FIG. 3A. As shown in FIG. 3A, the drive pulley 52a rotating around the axis AX1 has external teeth arranged at a predetermined pitch width P. Further, the driven pulley 52b rotating around the axis AX2 also has external teeth arranged at the pitch width P.

Further, as shown in FIG. 3B, the belt 52c also has internal teeth disposed at the pitch width P. Accordingly, as shown in FIG. 3A, in the case where the belt 52c is wrapped around the drive pulley 52a and the driven pulley 52b, the internal teeth of the belt 52c engage with the external teeth of the drive pulley 52a and the driven pulley 52b. Thus, it is possible to transmit the rotation of the motor 51 (see FIG. 2A) between the axis AX1 and the axis AX2 parallel to each other.

Meanwhile, the belt 52c is generally formed of an elastic material such as rubber, and the pitch width P of the internal teeth may vary due to an error at the time of molding. In this case, a case where the rotation angle of the driven pulley 52b is advanced or delayed with respect to the rotation angle of the drive pulley 52a, i.e., rotation unevenness is likely to occur.

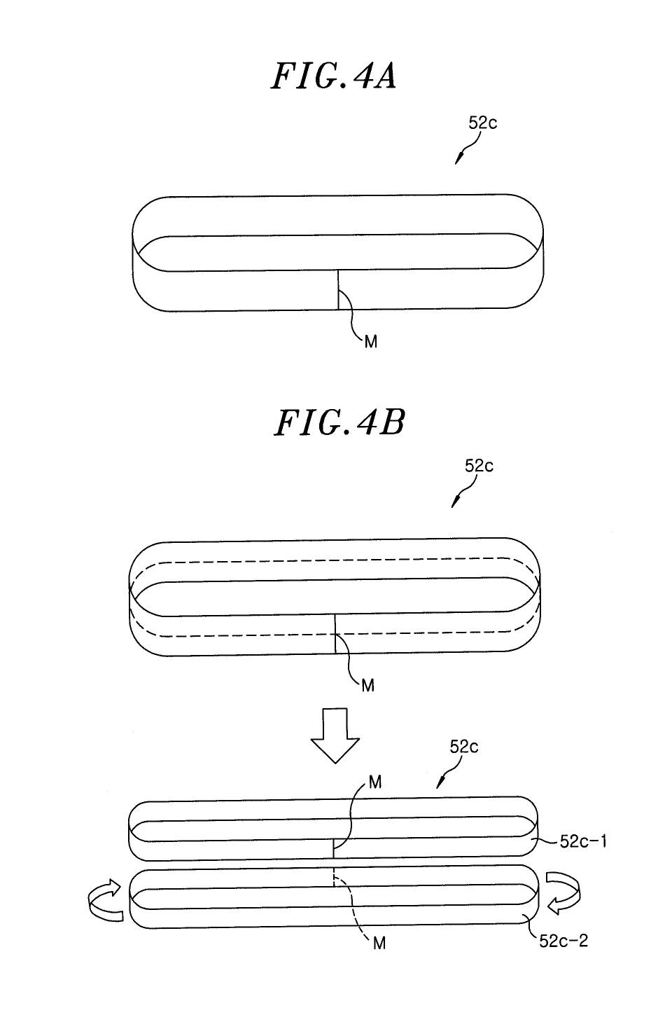

In the transmission mechanism 52 in accordance with the embodiment, the rotation unevenness is reduced by shifting phases of periodic variation characteristic of the teeth pitch width of the sub-belts of the belt 52c from each other. This will, be described in detail with reference to FIGS. 4A and 4B.

FIGS. 4A and 4B are diagrams illustrating an example of displacing the phases of periodic characteristics of the teeth pitch width variation of the belt 52c. Further, in the following description, periodic characteristics of variation of teeth pitch width P during one lap of the belt 52c are explained.

Here, as shown in FIG. 4A, for convenience description, a line M marks a certain position on the belt 52c. This is the same for FIG. 4B.

First, as shown in an upper portion of FIG. 4B, one belt 52c is configured to be divided into a plurality of sub-belts in this embodiment. For example, the belt 52c is cut along a dashed line shown in the upper portion of FIG. 4B as a cutting line. Accordingly, one belt 52c is divided into two sub-belts 2c-1 and 52c-2 as shown in a lower portion of FIG. 4B.

Then, as shown in the lower portion of FIG. 4B, for example, the sub-belt 52c-2 is rotated by 180 degrees corresponding to a half lap (see curved arrows and a dashed-line marking M in the figure). Further, while maintaining the position of each marking M shown in FIG. 4B, the two sub-belts 52c-1 and 52c-2 are wrapped around the drive pulley 52a and the driven pulley 52b. That is, the two sub-belts 52c-1 and 52c-2 are respectively arranged so that 2.5 phases of the periodic characteristics of teeth pitch width variations thereof are shifted from each other by 180 degrees.

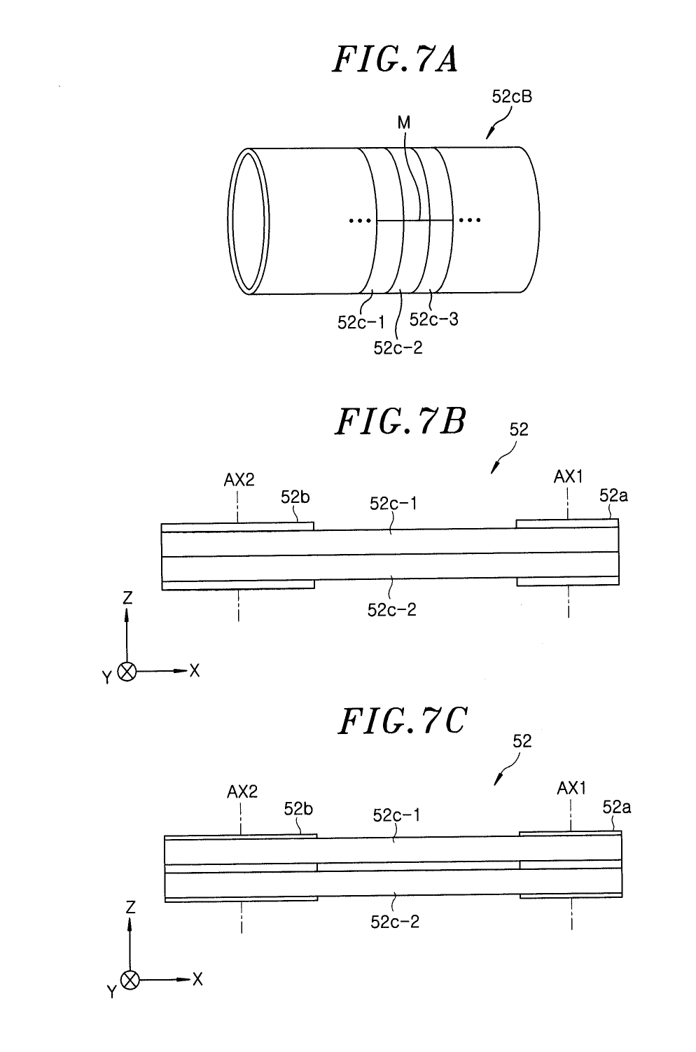

Herein, facing ends of the sub-belts 52c-1 and 52c-2 may be bonded to each other, or may be arranged side by side without bonding. This will be described later with reference to FIGS. 7B and 7C.

Further, an example of rotating the sub-belt 52c-2 by 180 degrees has been illustrated, but the sub-belt 52c-1 may be rotated in the same manner.

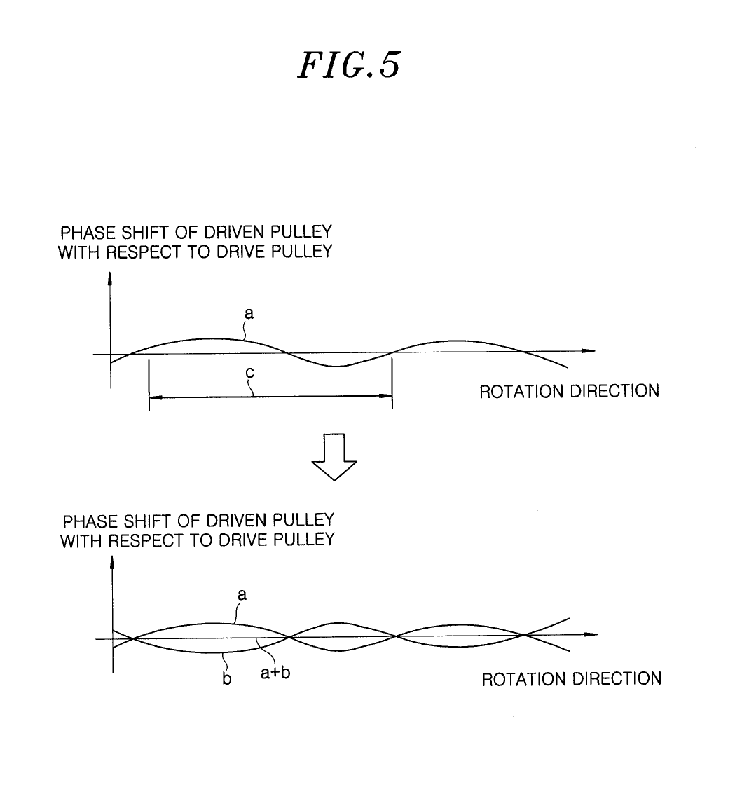

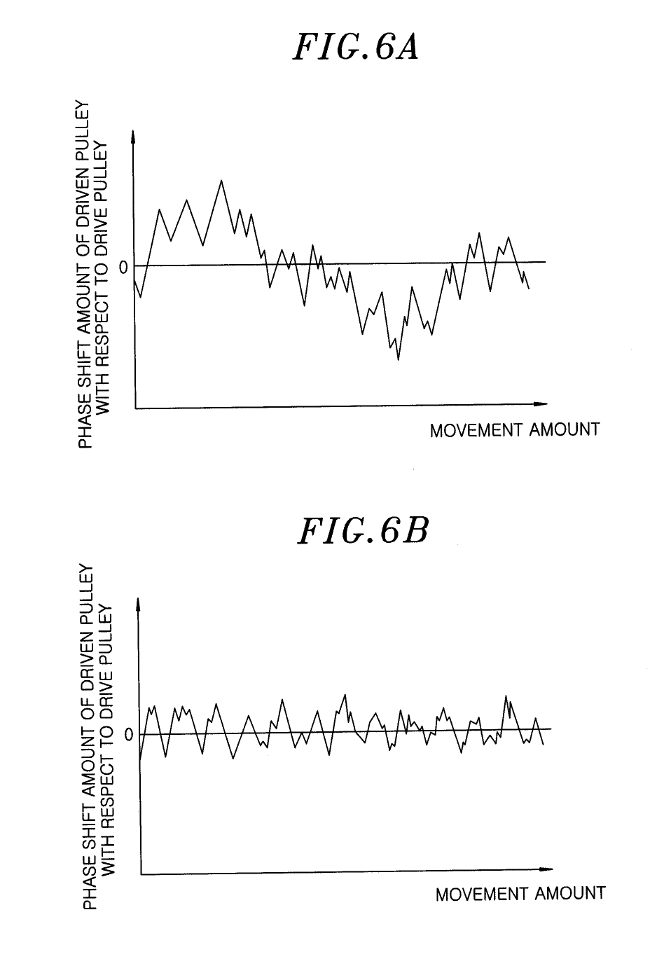

Here, in the case at displacing phases of periodic characteristics of the two sub-belts forming the belt 52c as shown in FIG. 4B, phase shift of the driven pulley 52b with respect to the drive pulley 52a and an amount thereof will be described with reference to FIGS. 5 and 6.

FIG. 5 is a graph showing the phase shift of the driven pulley 52b with respect to the drive pulley 52a, and FIGS. 6A and 6B are graphs showing experimental results of the shift amount of the driven pulley 52b with respect to the drive pulley 52a. Further, a state before the phases of the periodic characteristics of the sub-belts is shifted in the belt 52c is illustrated in an upper portion of FIGS. 5 and 6, and a state after shifting the phases of the periodic characteristics of the sub-belts is illustrated in a lower portion of FIGS. 5 and 6.

In the case where the phase of the belt 52c is not shifted as shown in the upper portion of FIG. 5, the phase shift of the driven pulley 52b with respect to the drive pulley 52a draws, for example, curve a that is similar to a sine wave varying up and down at a constant cycle c depending on the advance or delay of the driven pulley 52b.

Assuming that the constant cycle c corresponds to one lap of the belt 52c, this means that the belt 52c has the periodic characteristic for each lap drawn as the curve a. Further, the constant cycle c need not be particularly one lap.

On the other hand, in the case where the belt 52c is divided into two sub-belts and phases of periodic characteristics of the sub-belts are shifted from each other by 180 degrees corresponding to a half lap (see FIG. 4B) of the belt by rotating at least one of the sub-belts, phase shift of curve b drawn by the sub-belt 52c-2 is added to the phase shift of the driven pulley 52b with respect to the drive pulley 52a (see the lower part of FIG. 5).

Thus, since the curve b cancels out the curve a drawn by the sub-belt 52c-1 substantially equal to the belt 52c before division, ideally, it is possible to cancel the phase shift of the driven pulley 52b with respect to the drive pulley 52a (see a+b in the lower portion of FIG. 5B).

In other words, even while using the belt 52c having the periodic characteristic in which the pitch width P of the teeth varies, it is possible to make the driven pulley 52b follow the drive pulley 52a. Accordingly, the rotation of the drive pulley 52a can be transmitted to the driven pulley 52b with high accuracy less than the variation of the pitch width P.

Further, how much the driven pulley 52b follows the drive pulley 52a can be more clearly represented by the amplitude of the shift amount of the driven pulley 52b with respect to the drive pulley 52a.

For example, the shift amount before shifting the phases in the belt 52c represents a relatively large amplitude from the shift amount “0” as shown in FIG. 6A.

On the other hand, in the case where the phases in the belt 52c are shifted (see FIG. 4B) from each other, since the phases is cancelled out each other as described above, it is possible to reduce the amplitude of the shift amount from the shift amount “0” as shown in FIG. 6B. That is, this shows that the driven pulley 52b is controlled to more efficiently follow the drive pulley 52a. Therefore, the rotation of the drive pulley 52a can be transmitted to the driven pulley 52b with high accuracy less than the variation of the pitch width P.

Although the example, in which the belt 52c is divided into two sub-belts and one of the sub-belts is rotated by 180 degrees to shift the phase of the belt 52c, has been described, the present disclosure is not limited so this example. For example, the belt 52c may be divided into three sub-belts, the phase being shifted by 120 degrees.

Moreover, although there has been described a case where the phase is shifted by equally splitting 360 degrees corresponding to one lap of the belt 52c according to the number of divisions of the belt 52c, the present disclosure is not limited to such a case. For example, the phase may be shifted arbitrarily.

In the case of arbitrarily displacing the phase, it is preferable to use a technique of determining by appropriately tuning or simulating a phase to be shifted, for example, such that the amplitude of the shift amount shown in FIG. 6B becomes the smallest value. Further, a shift phase may be determined such that the phase shift curves a and b as shown in FIG. 5, for example, may be configured to cancel out each other as much as possible.

The fact that the phase can be shifted arbitrarily in this way may mean that the accuracy at which the driven pulley 52b follows the drive pulley 52a can be operated arbitrarily.

Next, an example of molding of the sub-belts will be described with reference to FIG. 7A. FIG. 7A is a diagram showing an example of molding of sub-belts 52c-1, 52c-2 and 52c-3.

As shown in FIG. 7A, the belt 52c is generally provided as a sliced member formed by cutting a tubular block 520B in a round shape at regular intervals. Further, the block 52cB may be non-uniformly formed due to an error during molding, as described above.

For that reason, in the case of molding the sub-belts 52c-1, 52c-2 and 52c-3 from the block 52cB, it is preferable to use sliced members adjacent to each other which are assumed to have similar errors.

For example, in the case where the belt 52c consists of two sub-belts, it is preferable to combine the sub-belts 52c-1 and 52c-2 or the sub-belts 52c-2 and 52c-3 formed by slicing the block 52cB after making a mark M on the block 52cB in advance in the example shown in FIG. 7A.

Further, in the case where the belt 52c is constituted by three sub-belts, it is preferable to combine the sub-belts 52c-1, 52c-2 and 52c-3 in the order.

With this configuration, since the belt 52c is constituted by the adjacent sliced members assumed to have similar errors, it is possible to easily achieve averaging of the periodic variation characteristic of the teeth pitch width P by shifting the phase. That is, the rotation of the drive pulley 52a can be easily transmitted to the driven pulley 52b with high accuracy having an error equal to or less than the variation of the pitch width P.

Next, an example of the arrangement of the sub-belts will be described with reference to FIGS. 7B and 7C. FIGS. 7B and 7C are diagrams showing an example of the arrangement of the sub-belts 52c-1 and 52c-2.

First, as shown in FIG. 7B, the facing ends of the sub-belts 52c-1 and 52c-2 may be joined to each other by adhesion or the like.

As shown in FIG. 7C, the sub-belts 52c-1 and 52c-2 may be arranged in parallel so that a distance between the facing ends of the sub-belts 52c-1 and 52c-2 becomes a predetermined gap equal to or greater than 0 (i.e., including the case where they are brought into contact with each other).

Further, since the sub-belts 52c-1 and 52c-2 are adjacent sliced members (see FIG. 7A), the sub-belts 52c-1 and 52c-2 may be disposed in reverse order. Further, the adjacent sliced members are used for ease of handling in this embodiment, but the sub-belts do not necessarily need to be the adjacent sliced members. That is, they may consist of sliced members which are formed from one tubular block 52c-3 and are not adjacent to each other as long as the same effect can be obtained. Further, they may be formed from separate tubular blocks 52cB. In addition, the sub-belts may not have the same width as long as the same effect can be obtained.

Although there has been described an example where the transmission mechanism 52 is provided in the substrate positioning device 50, the transmission mechanism 52 may be included in the robot of the transfer system 1. Hereinafter, this case will be described with reference to FIG. 8.

FIG. 8 is a schematic side view showing the configuration of the robot 10 in accordance with the embodiment. In FIG. 8, the hand 11 and the arm unit 12 of the robot 10 shown in FIG. 1 are more specifically illustrated. Further, assuming that a lower hand 11 is provided in the same form as an upper hand 11, the lower hand 11 is represented by a dashed line and a description thereof will be omitted. Further, the transmission mechanism included in the robot 10 is denoted by reference numeral 52′.

As shown in FIG. 8, the robot 10 includes the hand 11, the arm unit 12 and the transmission mechanism 52′. The arm unit 12 includes a first arm 12c, a joint unit 12d, a second arm 12e, and a joint unit 12f.

The first arm 12c is pivotally connected to a lifting unit (not shown) which is provided slidably in the vertical direction (Z-axis direction) with respect to the base 13 (see FIG. 1).

Further, the joint unit 12d is a joint rotating around an axis a1. As shown in FIG. 8, the joint unit 12d is constituted by, e.g., a motor 51′ and a drive pulley 52a′ connected to an output shaft of the motor 51′.

The second arm 12e is pivotally connected to the first arm 12c through the joint unit 12d.

Further, the joint unit 12f is a joint rotating around an axis a2. As shown in FIG. 8, the joint unit 12f is configured to include, e.g., a driven pulley 52b′ to which the rotation is transmitted from a drive pulley 52a′ through a belt 52c′.

Further, two or more driven pulleys 52b′, each being the same as that shown in FIG. 8, may be provided such that the rotation is transmitted through two or more belts 52c′.

The hand 11 is pivotally connected to the second arm 12e through the joint unit 12f.

Then, each belt 52c′ is composed of a plurality of sub-belts as in the case of the transmission mechanism 52, and the sub-belts are disposed by displacing the phase of the periodic variation characteristic. By providing the transmission mechanism 52′ as such, the robot 10 can operate the arm unit 12 and the hand 11 by transmitting the rotation of the motor 51′ with high accuracy less than the variation of the teeth pitch width P while achieving the light weight of the arm unit 12.

Thus, it is possible to improve the operation accuracy of the robot 10 in which a precise operation is required. Further, since it is possible to reduce the rotation unevenness of the belt 52c′ which becomes a factor of vibration, the operation accuracy of the robot 10 can be further improved.

As described above, each of the transmission mechanism, the substrate positioning device and the robot in accordance with the embodiment includes a drive pulley, a driven pulley, and a belt. The drive pulley is provided on the drive shaft, and has external teeth with a predetermined pitch width. The driven pulley is provided on the driven shaft, and has external teeth with the pitch width. The belt has internal teeth with the same pitch width, which engage with the external teeth of the drive pulley and the driven pulley. Further, the belt is composed of a plurality of sub-belts in which the pitch width varies at regular intervals, and the sub-belts are disposed in a state where the phase of the periodic variation characteristic of the teeth pitch width is shifted.

Therefore, according to the transmission mechanism, the substrate positioning device and the robot in accordance with the embodiment, even while using the belt having a periodic characteristic in which the pitch width of the teeth varies periodically, the rotation of a driving source can be transmitted with high accuracy less than the variation of the pitch width.

In the above-described embodiment, an example where a motor is used as the driving source has been described, but it is needless to say that a decelerator may be applicable between the motor and the drive pulley. In this case, the drive pulley is provided at an output shaft of the decelerator serving as the drive shaft.

In the above-described embodiment, a case where the substrate is mainly a wafer has been described by way of example, but it is needless to say that the PRESENT disclosure can be applied regardless of types of substrate.

Further, in the above-described embodiment, a single-arm robot has been described by way of example, but the embodiment disclosed herein can also be applied to a multi-arm robot having two or more arms.

Furthermore, in the above-described embodiment, the transmission mechanism included in the substrate transfer system has been described by way of example. However, it does not matter the type of system including the transmission mechanism. In addition, the transmission mechanism may be provided in an apparatus other than the system, and it does not matter the type of apparatus as well.

It should be understood by those skilled in the art that various modifications, combinations, sub-combinations and alterations may occur depending on design requirements and other factors insofar as they are within the scope of the appended claims or the equivalents thereof.

1. A transmission mechanism comprising:
a drive pulley which is provided on a drive shaft and has external teeth with a predetermined pitch width;
a driven pulley which is provided on a driven shaft and has external teeth with the pitch width; and
a belt having internal teeth with the pitch width which engage with the external teeth of the drive pulley and the driven pulley,
wherein the belt includes sub-belts having a periodic variation characteristic in which the pitch width varies periodically, and the sub-belts are arranged in a state where phases of the periodic variation characteristic thereof are shifted from each other.

2. The transmission mechanism of claim 1, wherein the number of the sub-belts is n, and the phase shift between the sub-belts is 360/n degrees.

3. The transmission mechanism of claim 2, wherein the number of the sub-belts is 2, and the phase shift between the sub-belts is 180 degrees.

4. The transmission mechanism of claim 1, wherein the sub-belts are adjacent sliced members formed by cutting a tubular member in a round shape at regular intervals.

5. The transmission mechanism of claim 3, wherein the sub-belts are adjacent sliced members formed by cutting a tubular member in a round shape at regular intervals.

6. The transmission mechanism of claim 1, wherein the belt is obtained by bonding facing ends of the sub-belts.

7. The transmission mechanism of claim 5, wherein the belt is obtained by bonding facing ends of the sub-belts.

8. The transmission mechanism of claim 1, wherein the belt is provided by disposing facing ends of the sub-belts with a predetermined gap therebetween, the gap being equal to or greater than 0.

9. The transmission mechanism of claim 5, wherein the belt is provided by disposing facing ends of the sub-belts with a predetermined gap therebetween, the gap being equal to or greater than 0.

10. A substrate positioning device comprising:
the transmission mechanism described in claim 1;
a motor which rotates the drive shaft; and
a substrate mounting table which is connected to the driven shaft and rotates in response to rotation of the driven shaft.

11. A substrate positioning device comprising:
the transmission mechanism described in claim 9;
a motor which rotates the drive shaft; and
a substrate mounting table which is connected to the driven shaft and rotates in response to rotation of the driven shaft.

12. A robot comprising the transmission mechanism described in claim 1.

13. A robot comprising the transmission mechanism described in claim 9.
